(19) United States
(12) Patent Application Publication
(10) Pub. No.: US 2020/0087959 A1
(43) Pub. Date: Mar. 19, 2020

(54) HINGE FOR A HINGED OPENING OF A VEHICLE

(71) Applicants: Audi AG, Ingolstadt (DE); PRINZ Kinematics GmbH, Stromberg (DE)

(72) Inventors: Richard SCHABENBERGER, Münchsmünster (DE); Paula WIRTH, Stromberg (DE)

(73) Assignees: Audi AG, Ingolstadt (DE); PRINZ Kinematics GmbH, Stromberg (DE)

(21) Appl. No.: 16/609,860

(22) PCT Filed: May 4, 2018
(86) PCT No.: PCT/EP2018/061477

§ 371 Date: Oct. 31, 2019

(30) Foreign Application Priority Data
May 5, 2017 (DE) 10 2017 004 342.6

(51) Int. Cl. E05D 7/00; E05D 3/02; E05D 5/10

(52) U.S. Cl. CPC E05D 7/0045; E05D 3/02; E05D 2007/0484; E05D 2005/102; E05D 5/10

(57) ABSTRACT

A hinge for a hinged opening of a vehicle includes a first hinge part and a second hinge part which are connected to one another via an axis of rotation so as to be movable relative to one another. The first hinge part has a slot and the second hinge part has a fitting hole. A screw is received through the slot of the first hinge part and fitting hole of the second hinge part. A shaped nut clamps the first hinge part and the second hinge part against the screw. The shaped nut forms a step that includes a first part received in the slot and a second part protruding from the first hinge part and resting on an edge of the slot.

### TECHNICAL FIELD

The present invention relates to a hinge for a hinged opening of a vehicle according to the preamble of claim 1 and to a hinged opening of a vehicle comprising at least one hinge of this kind.

### BACKGROUND

Hinges for hinged openings of vehicles are known in numerous variations and include a first hinge part and a second hinge part, which are connected to one another via an axis of rotation so as to be movable relative to one another. The first hinge part has a slot and the second hinge part has a fitting hole through which a screw is guided, which is clamped by a shaped nut.

From DE 10 2009 022 939 A1 a generic hinge for a front hinged opening of a vehicle is known, which has a lower hinge part and an upper hinge part, which are connected via a clamping screw with each other. A device for adjusting the height of the front hinged opening comprises a hole in a hinge part and a slot in the other hinge part through which the clamping screw is passed and after tightening a nut the clamping screw can be clamped such that, when using a bushing, the height adjustment can be fixed and the relative mobility of the hinge parts are guaranteed.

### SUMMARY OF INVENTION

The object of the present invention is to provide a hinge for a hinged opening of a vehicle and a hinged opening of a vehicle comprising at least one hinge of this kind, which has a reduced length of a hinge axis with the same length of a nut thread.

According to embodiments of the present invention the object is achieved by providing a hinge for a hinged opening of a vehicle with the features of claim 1 and by a hinged opening of a vehicle with the features of claim 9. Advantageous embodiments and further developments of the invention are specified in the dependent claims.

In order to provide a hinge for a hinged opening of a vehicle, which has a reduced length of a hinge axis with the same length of a nut thread, a shaped nut forms a step, wherein a first part of the step is inserted into a slot and a second part of the step protrudes from a first hinge part and rests on one edge of the slot.

In the following, a hinge is understood to mean an assembly having a first hinge part and a second hinge part, which are connected to one another via an axis of rotation so as to be movable relative to one another. The first hinge part has the slot and the second hinge part has a fitting hole through which a screw is guided. The screw is clamped by the shaped nut. In this case, the nut in the tightened state fixes, on the one hand, the position of the screw and thereby the position of the rotation axis in the slot and, on the other hand, it allows a relative rotational movement between the two hinge parts about the axis of rotation of the screw. Tolerance compensation is possible through the slot between two vehicle parts connected to the hinge parts. For example, an installation position of the hinged opening of a vehicle on the body can be changed or adjusted through the slot.

In addition, a hinged opening of a vehicle comprising at least one hinge of this kind is proposed.

Advantageously, the thread of the shaped nut can be at least partially embedded with the first part of the step in the slot, such that the usable thread length of the nut thread remains the same and the second part of the step, which protrudes from the first hinge part, can be shortened. Advantageously, a length of the screw, which is guided through the slot of the first hinge part and the fitting hole of the second hinge part and tightened by the shaped nut, can be reduced. By nesting the shaped nut and the slot and the length reduction of the screw and of the second part of the shaped nut achieved thereby, said second part protruding from the first hinge part, the space occupied by the hinge according to an embodiment of the present invention can be reduced in an advantageous manner. As a result, damage to body components by the hinge according to the invention can advantageously be reduced or completely prevented in an accident situation in bottlenecks.

In an advantageous embodiment of the hinge according to the present invention, the first part of the shaped nut can form a pin with an internal thread. In addition, the internal thread can completely penetrate the shaped nut. As a result, the usual usable thread length of the shaped nut can be achieved in an advantageous manner.

In a further advantageous embodiment of the hinge according to the present invention, the shaped nut can be mounted so as to be longitudinally movable along at least one guide element along the slot on the first hinge part. Advantageously, the guide element can form a rotation lock. By preventing rotation, the screw can be screwed into the shaped nut without another counter-holding tool. In addition, the screw can be guided with the guided shaped nut in the slot.

In a further advantageous embodiment of the hinge according to the present invention, the at least one guide element can be designed as a projection which runs at least next to a side edge of the slot and which guides a flattened region of the shaped nut, said region being adjacent to the projection. In this case, the shaped nut can advantageously be guided outside on a surface of the first hinge part. The at least one projection can preferably be introduced as a caulking next to the slot into the first hinge part.

In an alternative embodiment of the hinge according to the present invention, at least one side wall of the slot can form the at least one guide element and guide a corresponding flattened region of the first part of the shaped nut embedded in the slot. Here, the shaped nut can be guided, locked in rotation, inside the slot of the first hinge in an advantageous manner.

In a further advantageous embodiment of the hinge according to the present invention, the screw may have an upset end portion. By the upset end portion, an unintentional complete release of the clamping connection between the screw and the shaped nut and also a deliberate separation of the shaped nut and the screw can be prevented in an advantageous manner. As a result, a removal of the screw from the slot and the fitting hole can be prevented in an advantageous manner, such that the hinged opening connected to the vehicle body via the hinge according to the invention can be prevented from being separated from the vehicle body. Thereby, an effective theft protection can be implemented.

### BRIEF DESCRIPTION OF FIGURES

Embodiments of the present invention are illustrated in the drawings and are explained in more detail in the following description. In the drawing, same reference numerals designate components that perform the same or analog functions. In the drawings:

FIG. 1 shows a schematic sectional view of an exemplary embodiment of a hinge for a hinged opening of a vehicle according to an embodiment of the present invention,

FIG. 2 shows a schematic perspective view of the hinge according to an embodiment of the present invention from FIG. 1 with a first exemplary embodiment of at least one guide element, and

FIG. 3 shows a schematic perspective illustration of the hinge according to an embodiment of the present invention from FIG. 1 with a second exemplary embodiment of the at least one guide element.

### DETAILED DESCRIPTION OF FIGURES

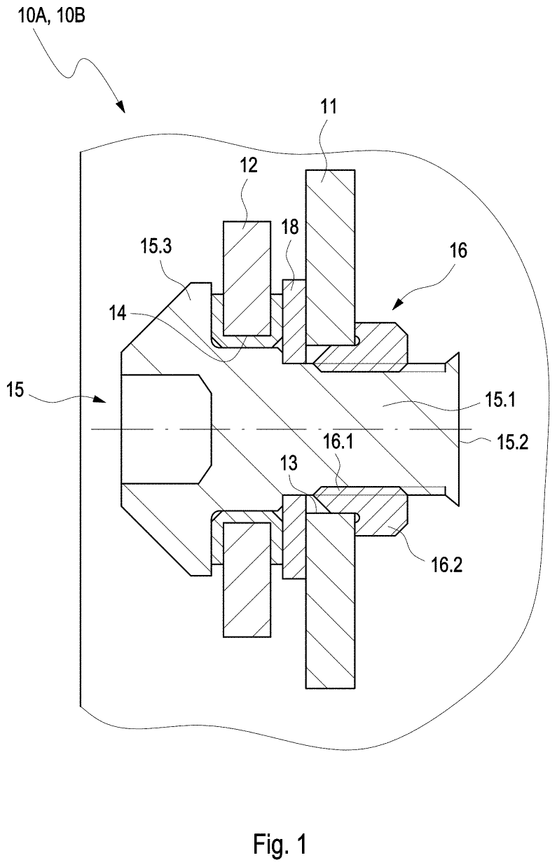

As shown in FIGS. 1 to 3, a hinge 10A, 10B for a hinged opening of a vehicle includes a first hinge part 11 and a second hinge part 12, which are connected to one another via an axis of rotation so as to be movable relative to one another. The first hinge part 11 has a slot 13, and the second hinge part 12 has a fitting hole 14. Through the slot 13 and through the fitting hole 14, a screw 15 is guided, which is clamped by a shaped nut 16.

According to various embodiments of the present invention, the shaped nut 16 forms a step, wherein a first part 16.1 of the shaped nut 16 is inserted into the slot 13 and a second part 16.2 of the shaped nut 16 protrudes from the first hinge part 11 and rests on an edge of the slot 13.

As shown in FIG. 1, the first hinge part 11 and the second hinge part 12 have mutually facing surfaces, between which a washer 18 is arranged. In the illustrated exemplary embodiments, the screw 15 is designed as a stepped screw, which includes a larger diameter in a first portion guided in the fitting hole 14 than a threaded portion 15.1 guided in the slot 13.

The two hinge parts 11, 12 are clamped between the screw head 15.3 and the shaped nut 16 such that the position of the screw and thereby the position of the axis of rotation is fixed in the slot but a relative rotational movement between the hinge parts 11, 12 is still possible. The screw 15 has an upset end portion 15.2. Here, the shaped nut 16 and the two hinge parts 11, 12 are arranged between the screw head 15.3 and the upset end portion 15.2 of the screw 15. As a result, disengagement of the hinged opening of a vehicle connected to a hinge part 11, 12 is made more difficult by a body component connected to the other hinge part 11, 12, and an effective theft protection is implemented. In addition, an unwanted complete release of the screw can be avoided in an advantageous manner. Between the upset end portion 15.2 and the shaped nut 16, the threaded portion 15.1 has a sufficient clearance to allow the release of the connection, which allows a displacement of the screw 15 and the shaped nut 16 along the slot 13.

As shown in FIGS. 1 to 3, the first part 16.1 of the shaped nut 16 forms a pin with an internal thread, which completely penetrates the shaped nut 16. Thereby, the expansion of the shaped nut 16 can be reduced along the axis of rotation maintaining the same thread length. The shaped nut 16 completely covers the slot 13 in the illustrated exemplary embodiment. A further embodiment is also conceivable in which the shaped nut 16 covers only the width of the slot 13 but not the entire length of the slot 13.

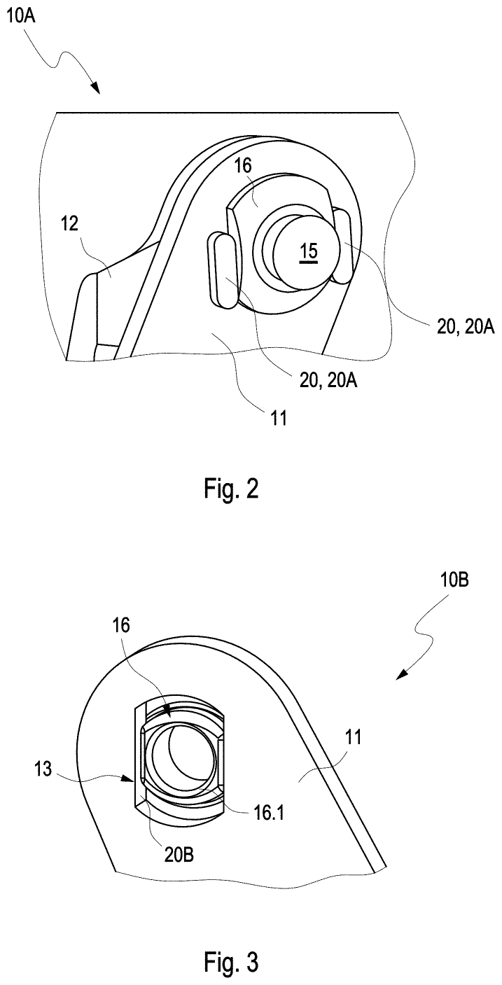

As shown in FIGS. 2 and 3, the shaped nut 16 is mounted so as to be longitudinally movable along at least one guide element 20 along the slot 13 on the first hinge part 11, wherein the guide element 20 forms a rotation lock.

The first embodiment of the hinge 10A according to an embodiment of the present invention illustrated in FIG. 2 differs from the embodiment of the hinge 10b shown in FIG. 3 by the at least one guide member 20.

As shown in FIG. 2, the at least one guide element 20 is designed as a projection 20A which runs at least next to a side edge of the slot 13 and which guides a flattened region of the shaped nut 16, said region being adjacent to the projection 20A. In the illustrated first exemplary embodiment, the second part 16.2 of the shaped nut 16 resting on the outside of the first hinge part 11 is disposed between two projections 20A, each extending along a side edge of the slot 13. The projections 20A can be easily inserted into the first hinge part 11 by caulking.

As shown in FIG. 3, at least one side wall 20B of the slot 13 forms the at least one guide element 20 in the illustrated second exemplary embodiment and guides a flattened region of the first part 16.1 of the shaped nut 16 embedded in the slot 13. In the illustrated second exemplary embodiment, both side walls 20B of the slot 13 each guide a flattened region of the first part 16.1 of the shaped nut 16 embedded in the slot 13, such that the shaped nut 16 is guided in the slot 13 in a manner locked against rotation.

### LIST OF REFERENCE NUMBERS

10A, 10B Hinge

11 First hinge part

12 Second hinge part

13 Slot

14 Fitting hole

15 Screw

15.1 Thread section

15.2 Compressed end area

15.3 Screw head

16 Shaped nut

16.1 First part

16.2 Second part

18 Washer

20 Guide element

20A Projection

20B Sidewall

[symbol]

1-9. (canceled)

10. A hinge for a hinged opening of a vehicle, comprising:
a first hinge part having a slot;
a second hinge part having a fitting hole;
a screw received through the slot of the first hinge part and the fitting hole of the second hinge part such that the first hinge part and the second hinge part are rotatably connected about the screw; and
a shaped nut clamping the first hinge part and the second hinge part against the screw;
wherein the first hinge part and the second hinge part are movable relative to one another about an axis of rotation defined by the screw,
wherein the shaped nut comprises a first part embedded in the slot of first hinge part and a second part protruding from the first hinge part and resting on an edge of the slot.

11. The hinge according to claim 10, wherein the first part of the shaped nut comprises a pin with an internal thread.

12. The hinge according to claim 11, wherein the internal thread extends through the shaped nut.

13. The hinge according to claim 10, further comprising:
at least one guide element disposed along the slot on the first hinge part,
wherein the shaped nut is mounted so as to be longitudinally movable along at least one guide element.

14. The hinge according to claim 13, wherein the at least one guide element is configured to lock the shaped nut from rotation.

15. The hinge according to claim 13, wherein the at least one guide element comprises a projection extending adjacent to a side edge of the slot, and
wherein the shaped nut comprises a flattened region disposed adjacent to the projection such that the projection guides the flattened region of the shaped nut in the longitudinal direction.

16. The hinge according to claim 13, wherein the at least one guide element comprises a side wall of the slot, and
wherein the shaped nut comprises a flattened region embedded in the slot such that the guide element is configured to guide the flattened region of the shaped nut in the longitudinal direction.

17. The hinge according to claim 10, wherein the screw has a compressed end region.

18. A hinged opening of a vehicle comprising:
at least one hinge, wherein each hinge comprises:
a first hinge part having a slot;
a second hinge part having a fitting hole;
a screw received through the slot of the first hinge part and the fitting hole of the second hinge part such that the first hinge part and the second hinge part are rotatably connected about the screw; and
a shaped nut clamping the first hinge part and the second hinge part against the screw;
wherein the first hinge part and the second hinge part are movable relative to one another about an axis of rotation defined by the screw,
wherein the shaped nut comprises a first part embedded in the slot of first hinge part and a second part protruding from the first hinge part and resting on an edge of the slot.
